(19) United States
(12) Patent Application Publication
(10) Pub. No.: US 2010/0073160 A1
(43) Pub. Date: Mar. 25, 2010

(54) ALERTING USERS USING A MULTIPLE STATE STATUS ICON

(75) Inventors: Kenneth Sean Gilmour, Issaquah, WA (US); Tedd K. Dideriksen, Woodinville, WA (US); Thomas H. Alphin, Kirkland, WA (US); Latika Kirtane, Seattle, WA (US); Chantal M. Leonard, Seattle, WA (US); Christopher J. Clark, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/237,432

(22) Filed: Sep. 25, 2008

(51) Int. Cl. G08B 21/00

(52) U.S. Cl. 340/540

(57) ABSTRACT

A user alert system is described that provides multiple dimensions of information to a user through a status icon. Initially the status icon displays a neutral state that informs the user that the user alert system is running, but there are currently no relevant alerts for the user to view. When the user alert system receives a lower priority alert, the system determines if the number of lower priority alerts received exceeds a threshold. If the number of lower priority alerts exceeds the threshold, then the user alert system modifies the status icon to display a low alert state. When the user alert system receives a higher priority alert, the system modifies the status icon to display a high alert state. Thus, the user alert system displays both the existence of alerts and the priority of the alerts to the user at the same time.

### BACKGROUND

Software applications have various ways of alerting a user to various events. For example, applications may display a dialog box, make a beeping sound, or use operating system provided facilities such as a system tray area for displaying icons or flashing the application window. Each of these ways of alerting a user is designed to get the user's attention and notify the user that something has happened that may make the user want to transition from whatever activity the user is currently working on to address the event that caused the alert.

Displaying an icon in the system tray is a popular way of notifying users that an application needs attention or is in a particular state. For example, Microsoft Outlook displays an envelope in the system tray when a user receives a new email message. As another example, Microsoft Windows Security Center displays a yellow or red icon when there are security warnings that the user needs to address. Each of these icons is designed to alert the user to information that may be relevant to the user, regardless of the application the user is currently working in.

One problem with notifying the user in this way is that the user can quickly become overloaded by the quantity and variety of notifications that the user receives. For example, a user may have a large number of status icons in his/her system tray. Microsoft Security Center in Microsoft Windows Vista attempts to solve this problem by collecting status information from a variety of event sources and displaying a single system tray icon that indicates whether any of the sources request user attention. This solution attempts to quiet the system by discouraging every application from having its own status icon. However, the quantity of event sources also increases the likelihood that there is always some problem displayed, and the user can very quickly learn to ignore the single status icon.

Another problem with this type of alert is that icons in the system tray are one-dimensional, meaning that they can only inform the user of one state that is either on or off. For example, the Microsoft Outlook new message icon informs the user that the user has an unread message, but it does not convey any additional information, such as the importance of the message. There is no way to give higher priority alerts more weight than lower priority alerts. In addition, if the user receives additional new messages, the icon will stay the same and the user will not know that there is a new reason to view his/her email inbox. Given that users often ignore non-critical notifications, there is no way to let the user know that there are new notifications available.

### SUMMARY

A user alert system is described that provides multiple dimensions of information to a user through a status icon. The status icon can convey multiple states and respond to various types of input. Initially the status icon displays a neutral state that informs the user that the user alert system is running, but there are currently no relevant alerts for the user to view. In some embodiments, the user alert system receives alerts that have different priorities, such as “important” and “critical,” where critical alerts have a higher priority and important alerts have a lower priority. When the user alert system receives a lower priority alert, the system determines if the number of lower priority alerts received exceeds a threshold. If the number of lower priority alerts exceeds the threshold, then the user alert system modifies the status icon to display a low alert state that indicates that there are enough relevant issues that the user should address. When the user alert system receives a higher priority alert, the system modifies the status icon to display a high alert state that indicates that there is a critical issue that the user should address. Thus, the user alert system displays both the existence of alerts and the priority of the alerts to the user at the same time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the user alert system, in one embodiment.

FIG. 2 is a flow diagram that illustrates the processing of the receive alert component of the user alert system, in one embodiment.

FIG. 3 is a flow diagram that illustrates the processing of the clear alert component of the user alert system, in one embodiment.

FIG. 4 is a state diagram that illustrates the status icon state in response to a variety of actions, in one embodiment.

### DETAILED DESCRIPTION

A user alert system is described that provides multiple dimensions of information to a user through a status icon. The status icon can convey multiple states and respond to various types of input. Initially the status icon displays a neutral state that informs the user that the user alert system is running, but there are currently no relevant alerts for the user to view. For example, the system may initially display a green stoplight. In some embodiments, the user alert system receives alerts that have different priorities, such as “important” and “critical,” where critical alerts have a higher priority and important alerts have a lower priority. Over time, the user alert system may receive one or more lower priority alerts. For example, one lower priority alert may indicate that the user should perform a backup of the user's computer system sometime soon. When the user alert system receives a lower priority alert, the system determines if the number of lower priority alerts received exceeds a threshold. If the number of lower priority alerts exceeds the threshold, then the user alert system modifies the status icon to display a low alert state that indicates that there are enough relevant issues that the user should address. For example, the system may display a yellow stoplight. The user alert system may also receive one or more higher priority alerts. For example, one higher priority alert may indicate that a graphics driver has encountered an unhandled exception and the user should upgrade the driver to maintain stability of the user's computer system. When the user alert system receives a higher priority alert, the system modifies the status icon to display a high alert state that indicates that there is a critical issue that the user should address. For example, the system may display a red stoplight. Thus, the user alert system displays both the existence of alerts and the priority of the alerts to the user at the same time.

In some embodiments, the user alert system modifies the status icon after a higher priority issue is resolved based on the state the status icon would be in without the higher priority alert. For example, if a threshold number of lower priority alerts arrives while the status icon is in the high alert state, the system sets the status icon to the low alert state rather than the neutral state when the higher priority alert is resolved. Thus, the system provides information to the user about the current alert based on the priority of currently unresolved issues at any given time.

In some embodiments, the user alert system clears alerts when the user displays an application. For example, the alerts may be designed to get the user to open an application for addressing the issues represented by the alerts. When the user opens the application, then the system may reset all of the alerts, regardless of whether the user has resolved all of the issues. In this way, the status icon informs the user of new issues, but does not continue to bother the user with old issues that the user has already had the opportunity to address through the application. For example, Microsoft Action Center alerts a user to a variety of types of issues, and provides a user interface (e.g., an application) where the user can view additional details about each issue and potentially resolve each issue. Once the user has seen the issues in the user interface, there is no longer an immediate reason to alert the user to the presence of the issues through the status icon. However, if new issues arise, then the system can again alert the user as described herein. In some embodiments, the system will continue to display the high alert state while critical issues remain unresolved, but will clear any lower priority alerts.

In some embodiments, the user alert system displays a notification in addition to the status icon when the state of the status icon changes. For example, the system may display a balloon or toast notification that pops up from the system tray when the status icon changes from the neutral state to the low alert state. The additional notification helps the user to notice the changed state. Because state changes for non-critical notifications are throttled by the threshold discussed herein, the user is less likely to ignore the notification. The user can click on the notification to open the application discussed above to view more details about the alerts that led to the notification. In some embodiments, the system displays the additional notification when the status icon is in the high alert state and a threshold number of new lower priority alerts arrive. This way if the user ignores a higher priority issue while other lower priority issues arrive, the system will inform the user of the arrival of the lower priority issues even though the status icon does not change.

The additional notification may also take other forms. For example, the user alert system may flash or pulse the status icon to indicate that the state of the icon has changed. Alternatively or additionally, the system may animate the icon to draw the user's attention to it when the state changes. The system may also use these techniques to notify the user about states that are not easily displayed with the status icon alone. For example, if the system receives a new critical alert while the status icon is already in the high alert state, the system may use the techniques described herein (e.g., displaying a balloon notification or flashing the icon) to draw the user's attention to the icon. As another example, the system may use these techniques as lower priority alerts are received, even before the number of lower priority alerts reaches the threshold.

In some embodiments, the system manufacturer or user can tune the alert threshold to determine how many lower priority alerts (e.g., three) the user alert system receives before modifying the status icon. The threshold can be set based on a variety of factors, such as user testing to determine how many alerts the system receives before a user pays attention to them, how frequently users can be alerted before they find the alerts annoying, how frequent alerts occur, and so on.

In some embodiments, the user alert system displays additional alert information when the user interacts with the status icon. For example, if the user hovers a cursor over the status icon, the system may display the current count of unresolved lower priority alerts and the current count of unresolved higher priority alerts. In this way, the user can get additional information about the alert state of the computer system without opening additional applications. In addition, if the user clicks on the icon, the system may provide a menu of options that allows the user to interact with the notifications. As another example, if the user double clicks the icon, the system may open the application described herein for resolving issues associated with the notifications.

In some embodiments, the user alert system modifies the state of the status icon based on time. For example, if the icon has been in the high alert state for a long time (e.g., a day) without the user addressing the alerts behind the high alert state, then the system may return the status icon to the neutral or low alert state, so that the user does not become trained to ignore the high alert state of the icon. As another example, if the system receives fewer than the threshold number of low priority alerts in a certain period (e.g., six hours), then the system may modify the status icon to display the low alert state, even though the threshold has not been reached.

In some embodiments, the user alert system displays additional states in the status icon. Although three states have been described herein (neutral, low alert, high alert) as examples, those of ordinary skill in the art will recognize that the techniques described herein can be used to display other states. For example, the status icon could display a busy state when the user's computer system is performing a long system maintenance operation (e.g., a system backup). When the operation completes, the user alert system returns the status icon to its former state. For each state, conditions exist for modifying the status icon to reflect that state (e.g., the threshold described herein), and the system sets a priority among states to determine which state to reflect in the icon when multiple states are true (e.g., the high alert state wins over the low alert state).

The user alert system as described herein can display status information for one or multiple applications. For example, an email application can employ the system to display a new mail notification icon that reflects the importance of messages received. For example, the high alert state may indicate high importance messages while the low alert state indicates a threshold number of normal or low importance messages. On the other hand, the system can be used to aggregate state information for multiple applications, such as system maintenance applications described herein. For example, the Microsoft Live suite of applications (e.g., Microsoft Windows Live Messenger and Microsoft Windows Live Hotmail) could employ the system to display information about new messages received at the same time as new contacts that come online. The system can treat a contact coming online as setting the high alert state for a short period while new messages set the low alert state. Those of ordinary skill in the art will recognize that the system described can be used in these and many other ways.

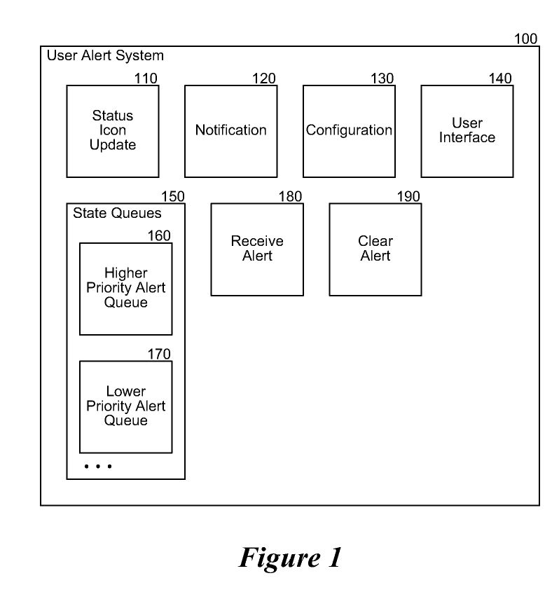

FIG. 1 is a block diagram that illustrates components of the user alert system, in one embodiment. The user alert system 100 includes a status icon update component 110, a notification component 120, a configuration component 130, a user interface component 140, a receive alert component 180, a clear alert component 190, and one or more state queues 150. For example, the figure illustrates a higher priority state queue 160 and a lower priority state queue 170. Each of these components is described in further detail herein.

The status icon update component 110 modifies the status icon based on the threshold set by the system and the priority established among alerts of various types. For example, the status icon update component 110 may not display a low alert state until a threshold number of lower priority alerts are reached, but may display a high alert state when any higher priority alert is received. The status icon update component 110 determines which icon state to display when new alerts are received and when existing alerts are cleared.

The notification component 120 generates notifications in addition to the status icon. For example, the notification component 120 may display the balloon notifications or other additional alerts described herein. The notification component 120 determines whether to display a notification when new alerts are received. For example, if a new lower priority alert arrives, the notification component 120 may display a notification regardless of the state of the status icon.

The configuration component 130 receives configuration information, such as the number and types of alert states. For example, the configuration component 130 may receive information about the possible alerts, the priorities among them, and a threshold number of an alert type to receive before displaying a state of the status icon related to that alert type. The configuration component 130 may be exposed to users so that a user can configure how the user wants to be notified, or may be an internal component that the system 100 uses to tune the performance and effectiveness of the system 100.

The user interface component 140 renders any user interface displayed to the user, such as the status icon, additional notifications, and any configuration interface. The user interface component 140 may submit requests to an operating system or other rendering library for performing common tasks such as loading an icon from a resource file and displaying the icon, animating the icon, and so forth. The user interface component 140 also responds to user actions such as clicking on notifications, hovering over the status icon, and so on as described further herein.

The receive alert component 180 receives new alerts. For example, the system 100 may provide an application programming interface (API) through which applications can provide new alerts to the system 100. The receive alert component 180 receives information about the type of alert and importance of the alert, and places the alert in the appropriate one of the state queues 150. The clear alert component 190 receives information about alerts that have been cleared. For example, a user may open an application for resolving alerts (e.g., the Microsoft Windows Solution Center) or perform an action in an application that changes the alert state (e.g., reading an email in Microsoft Outlook). Like the receive alert component 180, the clear alert component 190 may receive information through an API or other common methods of interprocess or intraprocess communication.

The state queues 150 store information about the alerts received, such as the count of alerts and their priorities. The state queues 150 may include separate queues for each alert type, such as the higher priority alert queue 160 and lower priority alert queue 170 illustrated in FIG. 1. Alternatively, the state queues 150 may include a single queue that stores alerts of all types along with information about the type of each alert. The queue may be ordered by priority so that the system 100 can determine which icon to display by accessing the head of the queue and determining the type and quantity of the type of alert at the head of the queue. For example, if the head of the queue contains a high priority alert, then the system 100 may display a high alert state through the status icon.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

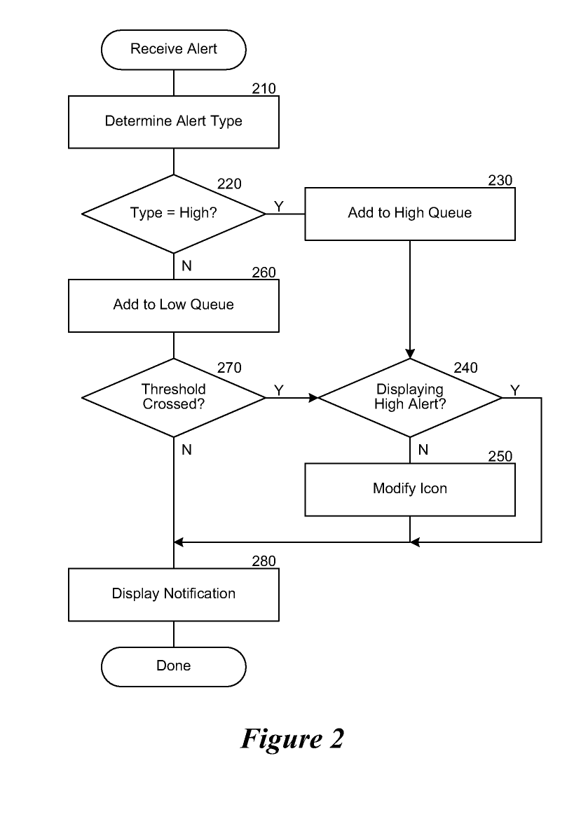

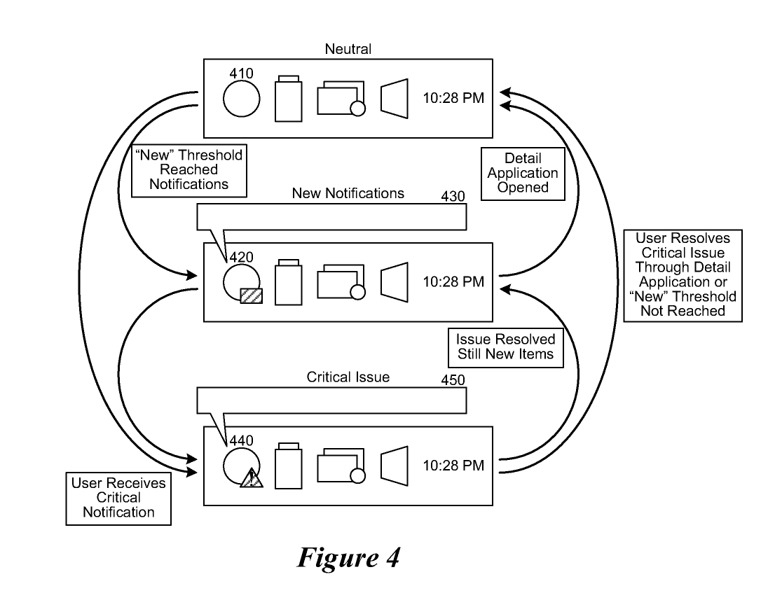

FIG. 2 is a flow diagram that illustrates the processing of the receive alert component of the user alert system, in one embodiment. The receive alert component is invoked when the system receives a new alert for potential display to the user. In block 210, the component determines the type of the received alert. For example, the alert may have an associated priority, state, or other type. In decision block 220, if the received alert is a higher priority type alert, then the component continues at block 230, else the component continues at block 260. In block 230, the component adds the alert to the higher priority alert queue. For example, the user alert system may provide a queue for each type or priority level of alert. In decision block 240, if the component is already displaying a high alert state through the status icon, then the component continues at block 280, else the component continues at block 250. For example, the system may have received previous higher priority alerts. In block 250, the component modifies the status icon to indicate a high alert state, as described further with reference to FIG. 4.

In block 260, the component adds the lower priority alert to the lower priority alert queue. In decision block 270, if the number of alerts now in the lower priority alert queue exceeds the threshold for modifying the status icon, then the component continues at block 240, else the component continues at block 280. As described above, in decision block 240, if the component is already displaying a high alert state through the status icon, then the component continues at block 280, else the component continues at block 250. For example, regardless of the new lower priority state, the system will keep the status icon at the high alert state if there are higher priority alerts in the higher priority alert queue. If there are no higher priority alerts, then crossing the lower priority alert threshold will cause the system to modify the status icon from the neutral to the low alert state.

In block 280, the component displays a notification, such as flashing the status icon or displaying a toast pop-up notification. The component may display the notification for new lower priority messages, even when the status icon is in the high alert state. Similarly, the component may display the notification for new higher priority messages, even though the status icon is already in the high alert state. Block 280 is optional, and in some embodiments may not occur. For example, when the system receives a lower priority alert and the threshold has not been met, the system may not display anything. In some embodiments, the system may flash or animate the icon rather than displaying the notification. After block 280, these steps conclude.

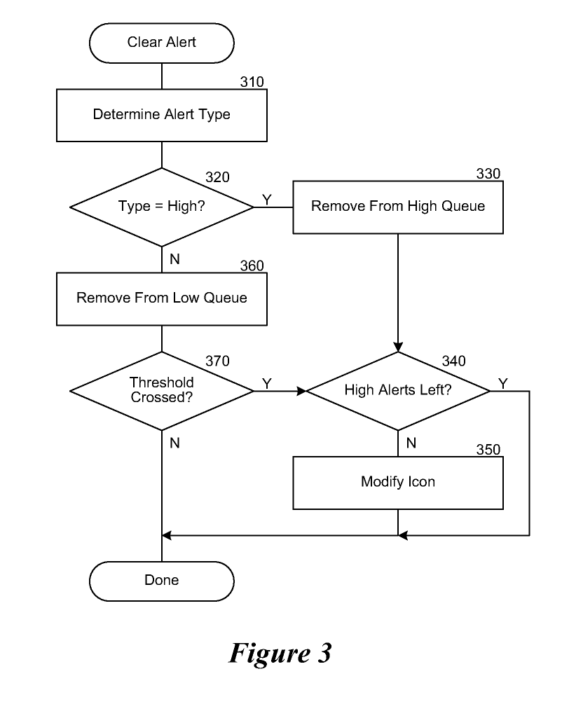

FIG. 3 is a flow diagram that illustrates the processing of the clear alert component of the user alert system, in one embodiment. The clear alert component is invoked when the user clears an alert, such as by resolving an issue associated with the alert in a system maintenance application. Alerts can be cleared in many ways, including based on the passage of time, received system updates, and so forth. In block 310, the component determines the type of the cleared alert. For example, the alert may have an associated priority, state, or other type. In decision block 320, if the cleared alert is a higher priority type alert, then the component continues at block 330, else the component continues at block 360. In block 330, the component removes the alert from the higher priority alert queue. For example, the user alert system may provide a queue for each type or priority level of alert. In decision block 340, if there are still higher priority alerts in the higher priority alert queue, then the component completes and continues to display the high alert state, else the component continues at block 350. For example, the system may have received several higher priority alerts that the user has not yet resolved. In block 350, the component modifies the status icon to indicate either a low alert or neutral state. For example, if there are new lower priority alerts in the lower priority alert queue, and their number exceeds the threshold, then the system modifies the icon to display the low alert state.

In block 360, the component removes the lower priority alert from the lower priority alert queue. In decision block 370, if the number of alerts now in the lower priority alert queue fell below the threshold for modifying the status icon, then the component continues at block 340, else the component completes and continues to display the low alert state. In some embodiments, whether the system continues to display the low alert state also depends on whether the user has opened an application for viewing additional details about the alerts (e.g., whether the alerts have been marked read in a manner similar to email). As described above, in decision block 340, if there are still higher priority alerts in the higher priority alert queue, then the component completes and continues to display the high alert state, else the component continues at block 350. For example, regardless of whether all lower priority issues have been resolved, the system will keep the status icon at the high alert state if there are higher priority alerts in the higher priority alert queue. If there are no higher priority alerts, then crossing the lower priority alert threshold will cause the system to modify the status icon from the low alert state to the neutral state. After block 350, these steps conclude.

FIG. 4 is a state diagram that illustrates the status icon state in response to a variety of actions, in one embodiment. In the first state 410, the status icon displays a neutral state that indicates to the user that there are currently no pressing issues for the user to address. If a lower priority alert is received that puts the quantity of lower priority alerts above the threshold, then the system moves to the second state 420. In the second state 420, the status icon displays a low alert state that indicates that there are important issues for the user to address. The system may also display the notification 430 with text explaining the events that led to a transition from the first state to the second state. If a new higher priority alert is received, then the system moves to the third state 440. In the third state 440, the status icon displays a high alert state that indicates that there are critical issues for the user to address. The system may also display the notification 450 with text explaining the nature of the new critical problem. If the user resolves the critical problem, then the system returns to either the second state 420 or the first state 410, depending on whether there are a threshold number of unresolved or new lower priority alerts after the critical problem is resolved (and whether the alerts have previously been viewed).

From the foregoing, it will be appreciated that specific embodiments of the user alert system have been described herein for purposes of illustration, but that various modifications may be made without deviating from the spirit and scope of the invention. For example, although a system maintenance application has been used in examples herein, the user alert system can operate with many types of applications or combinations of applications to facilitate conveying the state of the application or applications to the user. Accordingly, the invention is not limited except as by the appended claims.

I/We claim:

1. A computer-implemented method for displaying a status icon having multiple states, the method comprising:
receiving an alert from an application that indicates an issue for a user to address;
determining a priority of the received alert;
if the received alert is a higher priority type alert,
adding the alert to a higher priority alert queue;
if the status icon is not displaying a high alert state, modifying the status icon to display a high alert state;
if the received alert is a lower priority type alert,
adding the alert to a lower priority alert queue;
if a number of alerts in the lower priority alert queue exceeds a threshold and if the status icon is not already displaying a high alert state, modifying the status icon to display a low alert state.

2. The method of claim 1 further comprising, if the received alert is a higher priority type alert and the status icon is already displaying a high alert state, displaying a notification that the alert was received.

3. The method of claim 1 further comprising, if the received alert is a lower priority type alert and the number of alerts in the lower priority alert queue does not exceed the threshold, displaying a notification that the alert was received.

4. The method of claim 1 further comprising receiving an indication that the user has addressed the issue related to the alert, and if the alert was a high priority type alert and there are no other alerts in the higher priority alert queue, modifying the status icon to display a neutral state.

5. The method of claim 1 further comprising receiving an indication that the user has addressed the issue related to the alert, and if (1) the alert was a high priority type alert, (2) there are no other alerts in the higher priority alert queue, and (3) the number of unread alerts in the lower priority alert queue exceeds the threshold, modifying the status icon to display a low alert state.

6. The method of claim 1 further comprising receiving an indication that the user has addressed the issue related to the alert, and if the alert was a low priority type alert and the number of alerts in the lower priority alert queue does not exceed the threshold, modifying the status icon to display a neutral state.

7. The method of claim 1 further comprising, after modifying the status icon, animating the icon to call attention to it.

8. The method of claim 1 further comprising, when the user hovers a cursor over the status icon, displaying information about the number of alerts of one or more types.

9. The method of claim 1 further comprising, if the system receives fewer than the threshold number of low priority type alerts in a predefined period, modifying the status icon to display the low alert state even though the threshold has not been reached.

10. A computer system for displaying multiple alert states to a user, the system comprising:
a status icon update component configured to modify a the status icon based on a threshold set by the system and the priority established among alerts of various types;
a receive alert component configured to receive new alerts from applications;
a clear alert component configured to receive information about alerts that have been cleared by the user;
a state queue configured to store information about the alerts received.

11. The system of claim 10 wherein the notification component generates a balloon notification.

12. The system of claim 10 wherein the notification component generates a toast pop-up notification.

13. The system of claim 10 wherein the state queue comprises a higher priority alert queue and a lower priority alert queue.

14. The system of claim 10 further comprising a notification component configured to generate notifications in addition to the status icon.

15. The system of claim 14 further comprising a user interface component configured to render the status icon and generated notifications.

16. The system of claim 10 further comprising a configuration component 130 configured to receive the value of the threshold.

17. A computer-readable storage medium encoded with instructions for controlling a computer system to modify a status icon based on user resolution of a problem, by a method comprising:
receiving an indication that a user resolved a problem with the computer system;
determining a priority of the resolved problem;
removing the problem from a problem queue;
if the resolved problem has a first priority and if the problem queue contains additional problems of the first priority, displaying a high alert state of the status icon;
if the resolved problem has a second priority and if the problem queue contains a number of additional problems of the second priority below a threshold for modifying the status icon, displaying a neutral state of the status icon.

18. The computer-readable medium of claim 17 further comprising, if the resolved problem is of the first priority and the problem queue contains no additional problems of the first priority, modifying the status icon to indicate a low or neutral alert state.

19. The computer-readable medium of claim 17 further comprising, if the resolved problem has a second priority and the problem queue contains a number of additional problems of the second priority exceeding a threshold for modifying the status icon, displaying a low alert state of the status icon.

20. The computer-readable medium of claim 17 further comprising, if the status icon has been in the high alert state for a predefined period without the user addressing a problem of the first priority, modifying the status icon to remove the high alert state.
